(19) United States
(12) Patent Application Publication
(10) Pub. No.: US 2007/0003129 A1
(43) Pub. Date: Jan. 4, 2007

(54) Semiconductor device-inspecting apparatus and semiconductor device-inspecting method

(75) Inventor: Jiro Matsuda, Miyagi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/475,071

(22) Filed: Jun. 27, 2006

(30) Foreign Application Priority Data
Jun. 27, 2005 (JP) P2005-186485

(51) Int. Cl. G06K 9/00

(52) U.S. Cl. 382/151

(57) ABSTRACT

An inspection apparatus for inspecting a pattern on a semiconductor substrate is provided and includes: an inspection unit having an objective lens for the inspecting; a table supporting a semiconductor substrate, the table being capable of rotating with respect to the inspection unit; and a position-controlling unit that rotates the table an angle relative to the inspection unit and fixes the table at a position of the angle.

### FIELD OF THE INVENTION

The invention relates to a semiconductor device-inspecting apparatus and a semiconductor device-inspecting method using same, and more particularly to the improvement of accuracy in detecting a defect on a semiconductor device frequently having a pattern extending oblique, as in the honeycomb-structured solid-state imaging device.

### BACKGROUND OF THE INVENTION

For solid-state imaging devices, the imaging pixel count has recently increased up to the giga-order or greater along with the tendency toward the scale-down in the pixel area. In such a situation, there is proposed a structure that a highly refractive layer for preventing reflection is formed over the photoelectric converter made by a photodiode while covering the periphery of a light receiver by a tungsten shade layer in order to reduce the smearing effect. Meanwhile, in a charge-transfer region, a charge-transfer electrode is formed between the regions of photodiodes.

As shown in FIG. 3, the solid-state imaging device of a honeycomb structure has photodiodes 30, constituting photoelectric converters, made octagonal in form Consequently, the shade layer has edges formed in an oblique direction. Furthermore, the charge-transfer electrodes 3a, 3b for the charge-transfer region are formed as a route extending in a direction oblique 45 degrees along the outer edge of the photodiode 30. Meanwhile, the vertical charge-transfer lines 40 are also formed as routes each extending through between the photodiodes, in a direction of oblique 45 degrees. After formed a pattern, inspection is conducted. There is proposed, say, a method to perform a scanning over a pattern in a direction so that, depending upon a result of comparison between the image data measured and the reference pattern stored in a reference-pattern storage, the defect extracted is determined for correctness by means of a defect detector, thereby detecting a defect point on the semiconductor wafer (JP-A-2004-363223).

In this manner, the inspection apparatus usually used is arranged for a scanning in a direction horizontal relative to inserting a semiconductor wafer. For this reason, for such a device as frequently having a pattern component in an oblique direction as in the honeycomb-structured solid-state imaging device, scanning is in a direction oblique relative to the pattern. Because of a difficulty in recognizing a pattern accurately, accuracy is not obtainable to a sufficient extent.

The semiconductor wafer, such as a silicon wafer, is formed with an orientation flat (hereinafter, ori-fla) as a linear cutout in a part of its periphery, thus structured having a featuring portion to determine a crystal orientation thereof. There are those provided with a V-formed cutout (notch) in a part of its periphery in place of such an ori-fla. Owing to the featuring portion, orthogonal two-axial directions (X and Y directions) are defined on the surface of a semiconductor substrate. Namely, in the case with a notch, vertical and horizontal directions can be defined for the semiconductor wafer where the notch is positioned in the lowermost thereof. Meanwhile, in the case with an ori-fla, the linear line of the linear-formed cutout can be taken horizontal in direction while the direction orthogonal to that be vertical in direction or so.

Usually, such a featuring portion is used in positioning to inspect a pattern. It is a practice to perform a scanning for an inspection in four directions of 0, 90, 180 and 270 degrees with reference to the position of the notch. For a honeycomb-structured solid-state imaging device, it is impossible to conduct an inspection in a direction along the pattern. Thus, there is a problem that inspection accuracy is impossible to obtain to a sufficient extent.

### SUMMARY OF THE INVENTION

An object of an illustrative, non-limiting embodiment of the invention is to provide a semiconductor device high in sensitivity and in reliability, which improves the inspection accuracy even in a defect inspection on a device having a pattern provided oblique in direction and realize.

According to an aspect of the invention, a semiconductor device-inspecting apparatus for inspecting (or testing) a pattern formed on a semiconductor substrate is provided. The apparatus includes: an inspection unit having an objective lens for the inspecting; a table supporting a semiconductor substrate, the table being capable of rotating with respect to the inspection unit; and a position-controlling unit that rotates the table an angle relative to the inspection unit and fixes the table at a position of the angle.

Due to the structure, by a rotation in accordance with the direction of a pattern, an inspection (or an inspection) can be conducted vertically to the pattern, thus improving inspection sensitivity in a given inspection time and improving the inspection accuracy.

The semiconductor device-inspecting apparatus may include a structure that the position-controlling unit has a stopper for fixing the table at each of a plurality of positions so that an inspection can be made in a plurality of directions previously determined.

Due to the structure, an inspection can be efficiently conducted in a desired direction.

The semiconductor device-inspecting apparatus may include a structure that the position-controlling unit further has a parallel-moving unit for moving (or displacing) parallel the semiconductor substrate for scanning.

Due to the structure, rotation and horizontal movement are made possible thus enabling an inspection in a desired direction.

The semiconductor device-inspecting apparatus may include a structure that the position-controlling unit has a stopper for fixing the table in two stages of 0 degree and 45 degree with respect to a reference direction, thus to conduct an inspection on a solid-state imaging device of a honeycomb structure.

Due to the structure, a pattern inspection can be easily conducted on a solid-state imaging device by a mere setting at 0 degree and then at 45 degrees.

The semiconductor device-inspecting apparatus may include a structure that the position-controlling unit is arranged on the table so that the table can be formed rotatable.

Due to the structure, a semiconductor wafer can be fixed on the table and positionally controlled, thus enabling control with accuracy.

The semiconductor device-inspecting apparatus may include a structure that the table is formed movable in a basic direction determined previously and in a direction oblique thereto.

Due to the structure, the table itself can be positionally controlled, thus enabling control with accuracy.

The semiconductor device-inspecting apparatus may include a structure that the table is formed to rotate at a minimal interval of 1 degree. (A minimum angle of rotation of the table is 1 degree.)

Due to the structure, accurate directional control is feasible.

The semiconductor device-inspecting apparatus may include a structure that the inspection unit has a plurality of objective-lens units for inspection, at least one of which is fixed and one of the others is rotatable.

Due to the structure, an inspection can be conducted accurately by merely rotating the objective-lens unit.

A semiconductor device-inspecting method according to an aspect of the invention is a method for inspecting a semiconductor substrate including a pattern formed in an oblique direction (i.e., the patter including a first pattern extending in a first direction and a second pattern extending in a second direction oblique to the first pattern). The method including: a step of scanning the first pattern along a direction vertical to the first direction by an inspection unit to inspect the first pattern; a controlling step of rotating a table supporting the semiconductor device an angle relative to the inspection unit and fixing the table at the angle; and a step of scanning the second pattern along a direction vertical to the second direction by the inspection unit to inspect to the second pattern.

Due to the method, an inspection can be conducted accurately for both the first and second patterns.

In the semiconductor device-inspecting method, the controlling step may include a step of switching a stopper for fixing at a plurality of positions and controlling the table so that an inspection (the scanning) can be made in a direction previously determined.

Due to the method, an inspection can be conducted accurately in a short time by merely changing over the stopper without requiring fine regulation.

In the semiconductor device-inspecting method, the controlling step may include a parallel-moving step of moving (or displacing) parallel the semiconductor substrate.

Due to the method, accurate positional regulation is feasible.

In the semiconductor device-inspecting method, a position-controlling unit having a stopper for fixing the table at two stages of 0 degree and 45 degrees with respect to a reference direction may be used. The method may include: a step of testing (scanning) the first pattern on a honeycomb-structure solid-state imaging device positioned in the 0-degree position; and a step of testing (scanning) the second pattern on the solid-state imaging device positioned in the 45-degree position.

Due to the method, an inspection can be easily realized for a honeycomb-structured solid-state imaging device.

In the semiconductor device-inspecting method, the controlling step may include a step of controlling the table by rotating same such that the scanning can be along a direction vertical to the second pattern to be inspected.

Due to the method, an inspection can be conducted accurately.

As explained so far, a semiconductor device-inspecting apparatus according to an aspect of the invention is provided with the position-controlling unit to conduct an inspection vertically also for a pattern in an oblique direction, thus enabling an inspection short in time and high in accuracy.

An inspection method in the invention can conduct an inspection in a direction corresponding to a pattern to be inspected, thus enabling a pattern test high in accuracy and in reliability.

### BRIEF DESCRIPTION OF THE DRAWINGS

FIGS. 1A and 1B are sectional views of a main part of a semiconductor substrate to be inspected in an inspection method of an exemplary embodiment of the invention.

FIGS. 2A and 2B are sectional views of a main part of a semiconductor substrate to be inspected in an inspection method of an exemplary embodiment of the invention.

FIG. 3 is a plan view showing a solid-state imaging device to be used in an exemplary embodiment of the invention.

FIG. 4 is a view showing a semiconductor device-inspecting apparatus in an exemplary embodiment of the invention.

### DETAILED DESCRIPTION OF THE INVENTION

With reference to the drawings, an exemplary embodiment of the invention will now be explained in detail.

A semiconductor device-inspecting apparatus is characterized by having a table formed rotatable relative to an inspection unit and a rotation-positioning unit for rotating the table a desired value relatively to the inspection unit and fixing it in the rotated position.

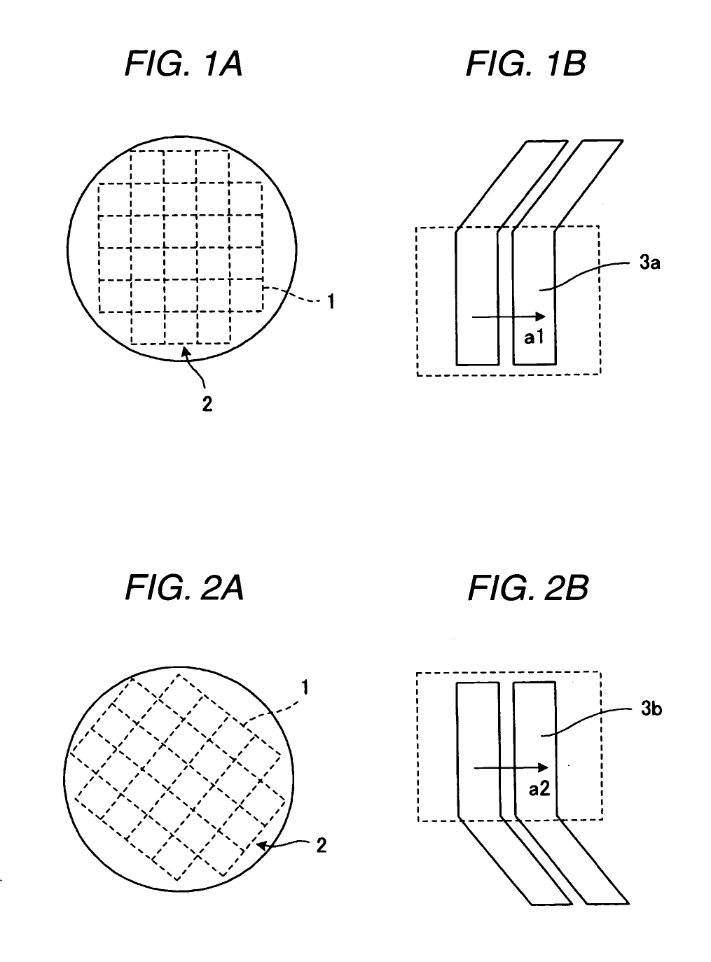

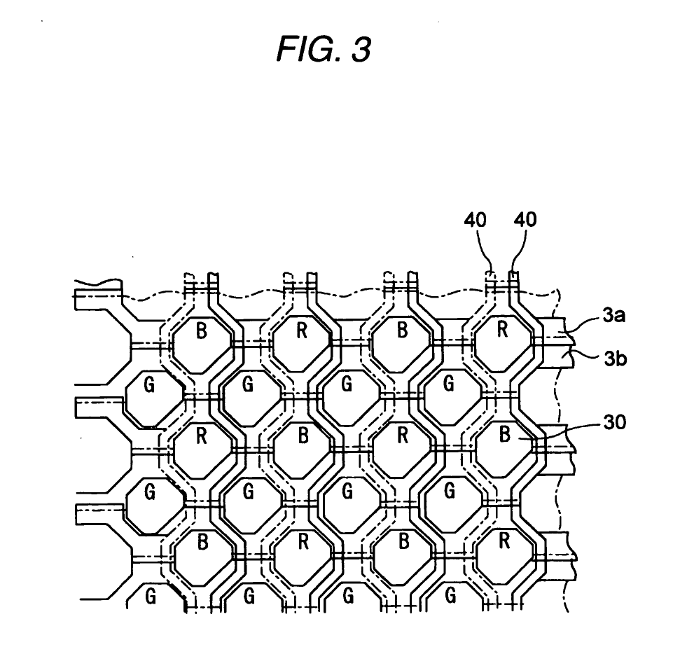

FIGS. 1A, 1B and 2A, 2B are plan views showing a semiconductor wafer, a subject to be inspected. In each figure, a semiconductor wafer is shown in each of FIGS. 1A and 2A wherein broken line 1 designates a dicing area while reference numeral 2 designates a position of a notch. In each of FIGS. 1B and 2B, there is shown an interconnect electrode pattern 3 typically of polysilicon formed over a semiconductor wafer. As shown a solid-state-imager plan view in FIG. 3, polysilicon 3a, 3b constitute charge-transfer electrodes extending in three directions of 0, 45 and 135 degrees.

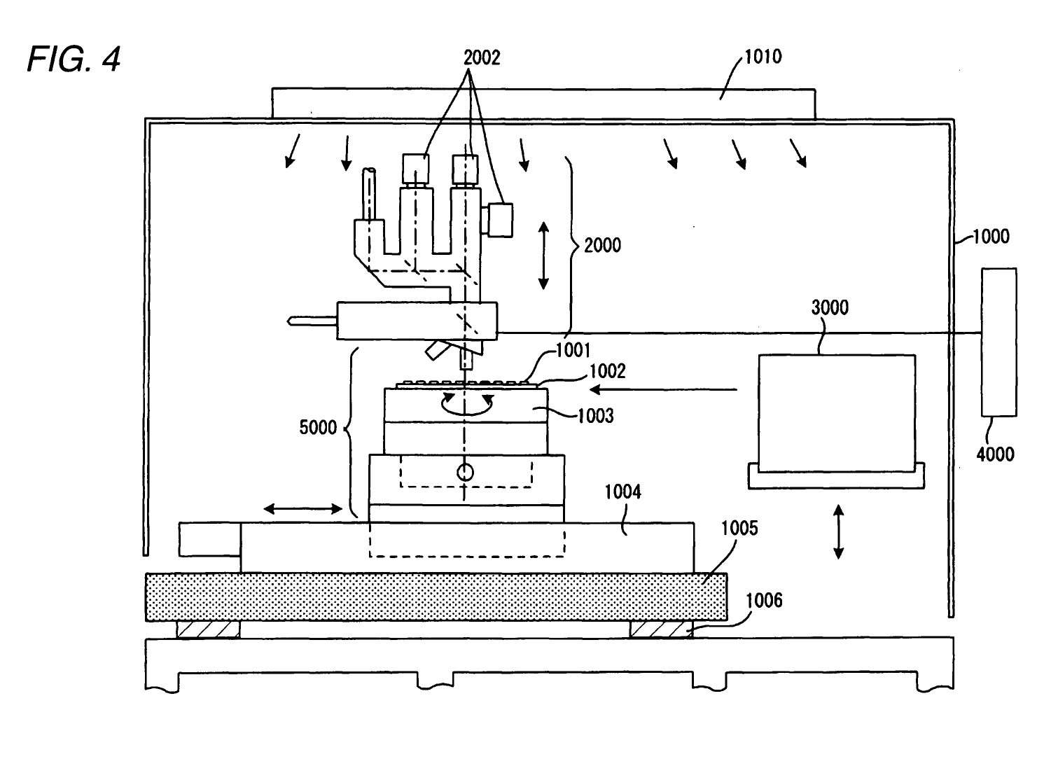

Namely, the test apparatus is arranged within a clean room as shown as a schematic explanatory view in FIG. 4. This includes: a clean booth 1000 whose interior is cleaned by supplying the air removed of foreign matters by means of the fan-filter unit 1010; an inspection unit 2000; an image processor 4000 for the inspection unit 2000 to take an image of a solid-state-imager wafer as a subject to be inspected, the subject being taken out of the magazine 3000; and a position-controlling unit 5000 for controlling a position of the wafer to be pattern-inspected, thereby extracting a defective pattern through image processing.

For example, a semiconductor wafer 1001, on which solid-state imaging devices are formed with a polysilicon interconnect pattern as a subject to be inspected, is aligned by the position-controlling unit such that scanning can be performed along a direction vertical to the interconnect pattern, followed by capturing an image. The data captured is image-processed by the image processor 4000 whereby a defect can be detected owing to the structure.

Within the clean booth 1000, there are further arranged a θ-stage 1003 for controlling a position (an angle) in a θ-direction, the semiconductor wafer with solid-state imaging devices rested upon the table 1002, an XY stage 1004 for controlling a position of the θ-stage 1003 rested thereon, and fixed base 1005 fixing the XY stage 1004 on the clean booth 1000 through anti-vibration rubber 1006.

Meanwhile, within the clean booth 1000, a magazine 3000 is movably arranged in a state receiving tables 1002 therein.

The inspection unit 2000 has a lens unit 2001 having an auto switchover function of light/dark field and objective lens, position-controlling unit 5000 for controlling a position of the lens unit, and a camera unit 2002 having an auto focus function. In the image processor 400, the captured data obtained by the camera unit 2002 is compared with a reference pattern thereby determining whether it is defective or not. Meanwhile, the inspection unit may be structured with two barrels, i.e. a fixed objective lens unit and a movable objective-lens unit.

In an inspection, the notch 2 is first positioned to below (in a reference direction, i.e., at 0 degree) as shown in FIGS. 1A and 1B. Measurement is conducted by performing a scanning over the polysilicon layer pattern 3a, in a direction widthwise “a1” of the pattern.

Then, the table 1002 is rotated by using the position-controlling unit 5000. By the θ-stage 1003 for controlling the position in the θ directional, the notch is adjusted directionally at 45 degrees as shown in FIGS. 2A and 2B, to conduct a measurement by a scanning over the polysilicon layer pattern 3b in the widthwise direction “a2” of the pattern. The image data thus obtained is image-processed by the image processor 4000, to thereby detect a detect presence/absence.

Where the direction of a pattern is previously known, a stopper is formed in a relevant point. By rotating the table 1002 and positioning is made based on the stopper point, measurement can be done in a significantly brief time.

As explained above, an inspection apparatus according to an aspect of the invention is useful in inspecting a device in various kinds, e.g. a solid-state imaging device, because of the capability of easily, accurately performing an inspection on a semiconductor wafer having thereon a pattern oblique in direction.

It will be apparent to those skilled in the art that various modifications and variations can be made to the described embodiments of the present invention without departing from the spirit or scope of the invention. Thus, it is intended that the present invention cover all modifications and variations of this consistent with the scope of the appended claims and their equivalents.

This application is based on Japanese Patent Application No. JP2005-186485 filed on Jun. 27, 2005, the contents of which is incorporated herein by reference.

What is claimed is:

1. An inspection apparatus for inspecting a pattern on a semiconductor substrate, which comprises:
an inspection unit having an objective lens for the inspecting;
a table supporting a semiconductor substrate, the table being capable of rotating with respect to the inspection unit; and
a position-controlling unit that rotates the table an angle relative to the inspection unit and fixes the table at a position of the angle.

2. The inspection apparatus according to claim 1, wherein the position-controlling unit comprises a stopper that fixes the table at each of a plurality of positions so that the inspection apparatus can inspect the semiconductor substrate along each of a plurality of directions.

3. The inspection apparatus according to claim 1, wherein the position-controlling unit comprises a parallel-moving unit that parallel displaces the semiconductor substrate so that the semiconductor substrate can be scanned by the inspection unit.

4. The inspection apparatus according to claim 1, wherein the position-controlling unit comprises a stopper that fixes the table at each angle of 0 degree and 45 degree so that the inspection apparatus can inspect a solid-state imaging device having a honeycomb structure.

5. The inspection apparatus according to claim 1, wherein the position-controlling unit is arranged on the table.

6. The inspection apparatus according to claim 5, wherein the table is movable in a basic direction and in a direction oblique to the basic direction.

7. The inspection apparatus according to claim 1, wherein a minimum angle of rotation of the table is 1 degree.

8. The inspection apparatus according to claim 1, wherein the inspection unit comprises a plurality of object lens units, at least one of the object lens units is fixed, and one of the other of the object lens units is rotatable.

9. A method for inspecting a semiconductor substrate including a first pattern extending in a first direction and a second pattern extending in a second direction oblique to the first pattern, the method comprises:
scanning the first pattern along a direction vertical to the first direction by an inspection unit to inspect the first pattern;
rotating a table supporting the semiconductor device an angle relative to the inspection unit and fixing the table at the angle; and
scanning the second pattern along a direction vertical to the second direction by the inspection unit to inspect to the second pattern.

10. The method according to claim 9, further comprising switching stoppers for fixing the table at a plurality of angles so that the scanning can be made along a direction previously determined.

11. The method according to claim 9, further comprising parallel displacing the semiconductor substrate.

12. The method according to claim 9, wherein
the semiconductor substrate is included in a solid-state imaging device having a honeycomb structure,
the scanning of the first pattern is performed after positioning the solid-state imaging device at an angle of 0 degree by a stopper of a position-controlling unit, and
the scanning of the second pattern is performed by positioning the solid-state imaging device at an angle of 45 degrees by the stopper of the position-controlling unit.

13. The method according to claim 11, wherein the rotating of the table is performed such that the second pattern can be scanned along a direction vertical to the second direction.
